(19) United States
(12) Patent Application Publication
(10) Pub. No.: US 2023/0037166 A1
(43) Pub. Date: Feb. 2, 2023

(54) Assays Combining Lateral Flow and Compressed Open Flow

(71) Applicant: Essenlix Corporation, Monmouth Junction, NJ (US)

(72) Inventors: Stephen Y. CHOU, Princeton, NJ (US); Wei DING, Princeton, NJ (US)

(73) Assignee: Essenlix Corporation, Monmouth Junction, NJ (US)

(21) Appl. No.: 17/879,748

(22) Filed: Aug. 2, 2022

Related U.S. Application Data
(60) Provisional application No. 63/228,299, filed on Aug. 2, 2021.

(51) Int. Cl. B01L 3/00

(52) U.S. Cl. CPC B01L 3/502; B01L 2200/0605; B01L 2200/0647; B01L 2400/0406; B01L 2300/161

(57) ABSTRACT

The disclosure provides a spacing-changeable device and a method using both lateral flow and compressed open flow for assaying a liquid sample. The device includes a first plate, a second plate, and an exterior liquid sample contact area. The spacing between the two plates are changeable to form different configurations including a first and second configurations. In the first configuration, the two plates face each other and form at least two gaps including a spacing-1 and a spacing-1′. The spacing height of the spacing-1′ has a size that allows a liquid sample to flow into the spacing-1′. In the second configuration, the two plates are pressed, which changes spacing-1 and spacing-1′ to spacing-2 and spacing-2′, respectively, and the spacing-2′ has a spacing height larger than that of spacing-2. In the second configuration, the sample flows and spreads in areas of spacing-2 and spacing-2′.

### CROSS-REFERENCE TO RELATED APPLICATION

This application claims priority to the US provisional applications with Ser. No. 63/228,299, filed on Aug. 2, 2021, the entire contents of which are incorporated herein by reference.

### FIELD

The disclosure herein generally relates to a device and method for assaying a liquid sample. Specifically, the disclosure relates to a device that can adopts different configurations with multiple spacing heights between two plates and a method for using the device to prepare a thin liquid layer via a lateral flow combined with a compressed open flow.

### BACKGROUND

Many bio/chemical assays involve analyzing a liquid sample in the form of a thin layer. Such bio/chemical assays include immunoassay, nucleotide assay, blood cell counting, chemical reactions, and other processes. In certain bio/chemical assays, a liquid sample is sandwiched between two plates, and it often requires the spacing between the two plates to be small for facilitating an assay measurement (e.g., better analysis of a cell). In some cases, the assay requires the spacing between the two plates to be about the size of a cell in a liquid sample or even smaller than the cell. When a liquid sample gets into the space between the two plates by a lateral flow from one opening between the two plates, the cells in a liquid sample would be hard to flow into the space between the two plates, if the spacing between the plates is about the cell size; or would not flow if the spacing is smaller than the size of the cell. There is a need to flow cells in a liquid sample into the space between two plates, where the spacing between the two plates is about or even smaller than the size of the cell,

### SUMMARY

The present invention describes, among other things, a device and a method that allow a flow of the cells in a liquid sample into the space between two plates, where the spacing between the two plates is about or even smaller than the size of the cell.

One aspect of the present invention is that a device and a method that allows a flow of the cells in a liquid sample into the space between two plates, where the spacing between the two plates is about or even smaller than the size of the cell, where the device and method combines a lateral flow with a compressed open flow.

The term “lateral flow” refers a flow of a liquid sample between a first plate and a second plate in the direction parallel to the plane of the plates, where the spacing between the two plates are fixed.

The term “compressed open flow” refers to a flow a liquid sample between a first plate and a second plate in the direction parallel to the plane of the plates, where the spacing between the two plates can be changed, and a compressing of the two plates reduces the spacing between the two plates, which, in turn, reduces the thickness of the liquid between the two plates and makes the liquid flow parallel to the plane of the plates.

The term “spacer” refers to a structure that regulate the spacing between two plates that are facing each other. Examples of the spacer is a pillar or a bead.

In certain embodiments, a device for flowing a liquid between two plates for an assay, includes a first plate and a second plate, wherein the spacing between the two plates are changeable to form different configurations including a first configuration and a second configuration, the first spacing of the first configuration is 200 um or less, and the second spacing of the second configuration is less than the spacing of the first spacing.

In an embodiment, the first spacing in the first configuration is larger than the size of the cell in the liquid sample, while the second spacing in the second configuration is less than the size of the cell.

In an embodiment, the first spacing in the first configuration has a size of a factor of 1 (i.e., the same as the cell size), 1.4, 1.6, 1.8, 2, 2.2, 2.4, 2.8, or 3 of the size of the cell in the liquid sample or in a range between any two of the above factors, while the second spacing in the second configuration has a size of 50%, 60%, 70%, 80%, 90%, 95%, 97%, or 90% of the size of the cell, or in a range between any two of the above percentages.

In an embodiment, the device further comprises an inlet that allows the sample to flow into the first spacing between the two plates.

In an embodiment, the device is a spacing-changeable device including a first plate, a second plate, and an exterior liquid sample contact area on an exterior location of the device. The spacing between the two plates is changeable to form different configurations, including a first and a second configurations. At the first configuration (configuration-1), the two plates face each other and form at least two gaps including a spacing-1 and a spacing-1′. The spacing-1′ has a spacing height larger than that of the spacing-1, and the spacing height of the spacing-1′ has a size that allows a liquid sample to flow into the spacing-1′. At the second configuration (configuration-2), the two plates are pressed, which changes spacing-1 and spacing-1′ to an spacing-2 and an spacing-2′, respectively, and the spacing-2′ has a spacing height larger than the spacing-2. At the second configuration, the sample flows and spreads in areas of spacing-2 and spacing-2′. In an embodiment, the exterior liquid sample contact area comprises or serves as an inlet that allows the sample deposited thereon to flow into the spacing-1′ between the two plates in the first configuration.

In an embodiment, the spacing-1 or spacing-1′ in configuration-1 is 10 um, 20 um, 30 um, 50 um, 100 um, 150 um, 200 um, 500 um, 1 mm or in a range between any two of the values.

In an embodiment, the spacing-2 or spacing-2′ in configuration-2 is 1 um, 2 um, 5 um, 10 um, 20 um, 30 um, 50 um, 100 um, or in a range between any two of the values.

In an embodiment, the ratio of the spacing height between the two gaps is 1.1 fold, 1.2 fold, 1.5 fold, 2 fold, 3 fold, 5 fold, 10 fold, 30 fold, 50 fold, 100 fold, or in a range between any two of the values.

In an embodiment, the spacing-2 or spacing-2′ has an area of 1000 um², 2500 um², 5000 um², 10000 um², 50000 um², 1 mm², or in a range between any two of the values.

In an embodiment, one of the plates is fabricated by imprint lithography. In an embodiment, one of the plates is fabricated by injection molding.

In an embodiment, one of the plates is flexible plate. In an embodiment, for a flexible plate, the fourth power of the inter-spacer-distance (ISD) divided by the thickness of the flexible plate (h) and the Young's modulus (E) of the flexible plate, ISD⁴/(hE), is equal to or less than 10⁶ GPa/um³. In an embodiment, the thickness of the flexible plate times the Young's modulus of the flexible plate is in the range of 300 GPa-um to 550 GPa-um. In an embodiment, both plates are flexible plates. In an embodiment, the ISD⁴/(hE) of the flexible plate is equal to or less than 10⁶ GPa/um³, and the thickness of the flexible plate times the Young's modulus of the flexible plate is in the range of 350 GPa-um to 550 GPa-um. In an embodiment, it has any combination of above ISD⁴/(hE) and the thickness of the flexible plate times the Young's modulus of the flexible plate.

In an embodiment, for a flexible plate, the fourth power of the inter-spacer-distance (ISD) divided by the thickness of the flexible plate (h) and the Young's modulus (E) of the flexible plate, ISD⁴/(hE), is equal to or less than 5×10⁶ GPa/um³. In an embodiment, the thickness of the flexible plate times the Young's modulus of the flexible plate is in the range of 350 GPa-um to 750 GPa-um. In an embodiment, the ISD⁴/(hE) of the flexible plate is equal to or less than 5×10⁶ GPa/um³, and the thickness of the flexible plate times the Young's modulus of the flexible plate is in the range of 350 GPa-um to 750 GPa-um. In an embodiment, it has any combination of above ISD⁴/(hE) and the thickness of the flexible plate times the Young's modulus of the flexible plate.

In an embodiment, the first plate is a flexible plate. In an embodiment, the second plate is a flexible plate.

In an embodiment, the spacers are periodically arranged.

In an embodiment, the inter spacer distance is 20 um, 40 um, 60 um, 80 um, 100 um, 120 um, 150 um, 200 um, 240 um, or any value between two.

In an embodiment, the device further includes a spacer between the first and second plates. In an embodiment, the spacer has a spacing height-3 and is removable from the device after the sample flows into the device in configuration-1. In an embodiment, the spacer is deformable, and during the pressing, the spacing height-3 can be much less than its original value or very close to 0.

In an embodiment, the device further includes spacers disposed on the first plate. In an embodiment, the spacers form a first pillar array at the area of spacing-1 and a second pillar array at the area of spacing-1′. In an embodiment, the first pillar array has a pillar height from 3 um to 6 um with an inter pillar distance of 100 um to 200 um and a pillar size around 5 um to 40 um. In an embodiment, the second pillar array has a pillar height from 10 um to 50 um with an inter pillar distance of 100 um to 200 um and a pillar size around 10 um to 40 um.

In an embodiment, the area of spacing-1 is about 0.5 mm in length and about 1 mm in width, and the area of spacing-2 is more than 2 mm in length and more than 2 mm in width.

In an embodiment, the spacing height-3 is between 50 um and 150 um. In an embodiment, the spacer for spacing height-3 is made of one or more materials selected from the group consisting of plastic, rubber, glass, semiconductor, cellulose fibers, polymer, and copolymer.

In an embodiment, the device further includes a coating on at least one interior opposing surface of at least one of the plates or both. In an embodiment, the coating uses hydrophilic treatment, including but not limited to dielectric material coating, silicon oxide coating, plasma treatment, ozone treatment, polymer coating, acid-base treatment, or surfactant chemical coating. In an embodiment, the wetting angle at one interior surface is 10°, 20°, 30°, 45°, 60°, 75°, or in a range between any of these values.

The disclosure also provides a method for an assay in a spacing-changeable device using both lateral flow and compressed open flow. In an embodiment, the method includes:
(a) obtaining the device of claim 1 at the first configuration;
(b) dropping a sample onto the exterior liquid sample contact area of the device at the first configuration;
(c) flowing the sample into the device;
(d) pressing the device into the second configuration;
(e) imaging and analyzing the sample in the device.

In an embodiment, the assay includes but not limit to colorimetric assay, immunoassay, cell counting, cell staining, and others.

### BRIEF DESCRIPTION OF THE DRAWINGS

The drawings described herein are for illustration purposes only and are not intended to limit the scope of the disclosure. Portions or elements of a drawing may not necessarily be in the same scale in the same drawing or across the drawings. A portion or element of a drawing may be shown exaggerated or enlarged to provide a detailed view of the portion or element. A portion or element of a drawing may also be enlarged when illustrated in the other drawing(s) for a detailed view. Reference may be made to the accompanying drawings that form a part of this disclosure and which illustrate embodiments described herein. Like references generally refer to like features.

FIG. 1 schematically illustrates a sectional view of a device with a changeable spacing height in accordance with an embodiment. FIG. 1(a) schematically illustrates the device in a configuration with a spacing for drawing a liquid sample between two plates by lateral flow. FIG. 1(b) schematically illustrates the device in a pressed configuration for compressing the liquid sample drawn between the two plates into a thin-layer sample.

FIG. 2 schematically illustrates a sectional view of a device with multiple and changeable spacing heights in accordance with an embodiment. FIG. 2(a) schematically illustrates the device in a configuration for drawing a liquid sample between two plates by lateral flow. FIG. 2(b) schematically illustrates the device in a pressed configuration for compressing the liquid sample drawn between the two plates into a thin-layer sample.

FIG. 3 schematically illustrates a sectional view of a device in different configurations with changeable multiple-spacing heights. FIG. 3(a) illustrates the device in a configuration for drawing a liquid sample between two plates by lateral flow. FIG. 3(b) schematically illustrates the device in a pressed configuration for compressing the liquid sample drawn between the two plates into a thin-layer sample.

FIG. 4 schematically illustrates a sectional view of a device in different configurations with changeable multiple-spacing heights. FIG. 4(a) illustrates the device in a configuration for drawing a liquid sample between two plates from an inlet on a plate of the device. FIG. 4(b) schematically illustrates the device in a pressed configuration for compressing the liquid sample drawn between the two plates into a thin-layer sample.

FIG. 5 schematically illustrates a device with changeable multiple-spacing heights for drawing and compressing a blood sample and microscopic images of the device for blood count measurement. FIG. 5(a) shows the top view of the device, and FIG. 5(b) shows a sectional view of the device with spacing 1 and spacing 2 on a pressed configuration. FIG. 5(c) shows a zoom-in view of the device containing un-diluted whole blood.

### DETAILED DESCRIPTION

The following detailed description illustrates certain embodiments of the invention by way of example and not by way of limitation. Any section headings and subtitles used herein are for organizational purposes only and are not to be construed as limiting the subject matter described in any way. The contents under a section heading and/or subtitle are not limited to the section heading and/or subtitle, but apply to the entire disclosure.

The term “a,” “an,” or “the” cover both the singular and the plural reference, unless the context clearly dictates otherwise. The terms “comprise,” “have,” “include,” and “contain” are open-ended terms, which means “include but not limited to,” unless otherwise indicated.

Certain values herein are preceded by the term “about.” The term “about” herein provides literal support for the exact value that it precedes, as well as a range that is near to or approximately the value that the term precedes. In an embodiment, the range is from 70% to 130% of the exact value that the term “about” precedes. In an embodiment, the range is from 80% to 120% of the exact value that the term “about” precedes. In an embodiment, the range is from 90% to 110% of the exact value that the term “about” precedes. In an embodiment, the range is from 99% to 101% of the exact value that the term “about” precedes. For example, if the exact value is 100, the range from 70% to 130% of the exact value is 70 to 130.

The terms “Q-card,” “QMAX-device,” “CROF Card (or card),” “COF Card,” “QMAX-card,” “CROF device,” “COF device,” “CROF plates,” “COF plates,” and “QMAX-plates” are interchangeable and refer to a device that comprises a first plate and a second plate that are movable relative to each other, which forms different configurations, including an open configuration and a closed configuration. The device may or may not comprise spacers that regulate the spacing between the first and the second plates.

The terms “first plate” or “second plate” are plates used in, for example, a QMAX-card described herein.

Unless indicated otherwise, the term “plate” refers to one of the first and second plates used in, for example, a QMAX-card, which is solid and has a surface that can be used, together with another plate, to compress a sample placed therebetween to reduce a thickness of a sample.

The term “plates” or “two plates” refers to the first and second plates used in the device described herein, for example, a QMAX-card.

The term “the plates are facing each other” refers to a configuration of the first and second plates where the first and second plates at least partially face each other.

Unless indicated otherwise, the term “spacers” refers to mechanical objects that can set a limit on the minimum spacing between the two plates when the spacers are disposed between the two plates and when the two plates are compressed against each other. Namely, in the compressing, the spacers can stop the relative movement of the two plates to prevent the spacing from becoming less than a preset (i.e., predetermined) value. The types of spacers can include an open spacer and an enclosed spacer. The term “open spacer” has a shape that allows a liquid sample to flow around the entire perimeter of the spacer and flow past the spacer. In some embodiments, a pillar is an open spacer. The term “enclosed spacer” has a closed shape that prevents a liquid sample from overflowing the entire perimeter of the spacer and flowing past the perimeter of the spacer. For example, a ring-shaped spacer is an enclosed spacer because it has a ring as a perimeter for holding a liquid sample inside the ring and preventing the liquid sample from flowing outside the ring.

The “inter-spacer distance” means the closest distance between two spacers of the same plate.

The “substantially uniform thickness” means a thickness that is constant or only fluctuates around a mean value, for example, by no more than 10%, preferably no more than 5%, or even more preferably no more than 1%. Likewise, the terms “substantially uniform,” “substantially identical,” or “substantially equal” mean uniform, identical, equal, or only fluctuation around a mean value, for example, by no more than 10%, preferably no more than 5%, even more preferably no more than 1%.

The term “and/or” means any one or more of the items in the list joined by “and/or.” As an example, “x and/or y” means any element of the three-element set {(x), (y), (x, y)}. In other words, “x and/or y” means “one or both of x and y.” As another example, “x, y, and/or z” means any element of the seven-element set {(x), (y), (z), (x, y), (x, z), (y, z), (x, y, z)}. In other words, “x, y, and/or z” means “one or more of x, y, and z.”

The embodiments described herein generally pertain to a device and method for a bio/chemical assay of a liquid sample in the form of a thin layer. Specifically, the embodiments relate to a QMAX card-based assay. More specifically, the embodiments relate to a device with multiple spacing heights and a method of using the device for improving sample distribution in a QMAX card-based assay. In some embodiments, the QMAX card can be a sample holding device of the iMOST system.

The embodiments herein can provide the advantage of, among others, improving the distribution of a liquid sample in a sample holding device for an assay through capillary force. The embodiments also provide an economic or convenient design to draw a liquid sample into a test area with relatively small spacing and then compress the sample into a thin layer for an assay. These advantages become more readily apparent upon reference to the following description and drawings. It is appreciated that the embodiments described herein are non-limiting embodiments and may be used in any applicable biological or chemical assays.

A lateral assay, that uses a capillary force to laterally draw a liquid sample into a space between two plates of a sample holder, has an advantage of relatively simple operation in introducing the sample inside an assay sample holder. However, for a sample containing cells and/or particles, the cells and/or particles cannot flow inside a spacing between two plates of a sample holder, if the spacing is less than the size of the cell and the particle; and become hard to flow inside a spacing between two plates of sample if the space is the sample or slightly larger than the spacing. There is a need to in assaying a sample containing cells or particles by placing sample between the two plates of a sample holder, wherein the spacing between the two plates are smaller, equal to, or slightly larger than the size of the cell or the particles.

Furthermore, in certain cases of a lateral flow assay, it is desirable to flow a sample a spacing between two plates of a sample holder when the spacing is larger than the final spacing when the sample is analyzed. There is a need to in laterally flow, with a capillary force, a sample a spacing between the two plates of a sample holder, using one spacing while analyzing the sample using a smaller spacing.

The disclosure relates to a device comprising two plates that can adopts different configuration with multiple spacing heights and a method for using the device to prepare a thin liquid layer via a lateral flow and compressed open flow. In an embodiment, the method involves placing a sample containing cells or particles between the two plates, wherein the spacing between the two plates are smaller, equal to, or slightly larger than the size of the cell or the particles.

The spacing-changeable device and method described herein, which uses both lateral flow and compressed open flow, can make the performance of an assay simple, rapid, and at low cost, and can be used anywhere by a non-professional.

In an embodiment, the spacing-changeable device using both lateral flow and compressed open flow for an assay comprises:
(a) two plates; the average spacing between the two plates are changeable to at least two value, thus two configurations;
(b) at first configuration (configuration-1), two plates facing each other, forming one gap with average spacing-1. There is an exterior liquid sample contact area on an exterior location of the device in this configuration for liquid to flow-in.
(c) at second configuration (configuration-2), two plates facing each other, forming one gap with average spacing-2.

In an embodiment, the device is a sample holder device. In an embodiment, the device is a QMAX card.

In some embodiments, the QMAX card can comprise two plates, including a first plate and a second plate. The first plate and the second plate can be movable relative to each other, which forms different configurations, including an open configuration and a closed configuration. In some embodiments of the open configuration, the first plate and the second plate are at least partially separated from each other, and at least one of the first plate and the second plate receives deposition of a sample. In some embodiments of the closed configuration, at least a portion of the deposited sample is compressed into a thin layer of substantially uniform thickness in contact with the first and second plates. In some embodiments, at least one of the two plates has a structural element. In some embodiments, the structural element comprises a plurality of spacers affixed thereon. In some embodiments, the first plate has a plurality of spacers affixed thereon. In some embodiments, the second plate has a plurality of spacers affixed thereon.

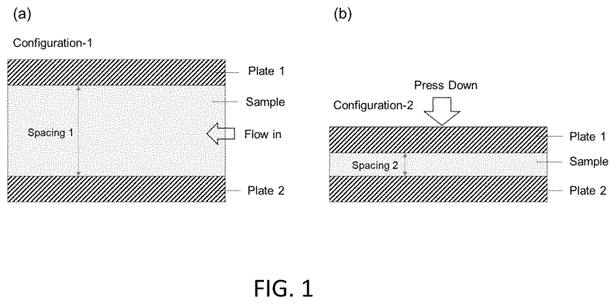

FIG. 1 shows an embodiment of the device and method for assay in a spacing-changeable device using both lateral flow and compressed open flow. The device comprises a first plate and a second plate. The sample is disposed between the first plate and second plate. (a) At configuration-1, the two plates form a gap with spacing-1, which allows the sample to flow into the device and be deposited between the first and the second plates. (b) At configuration-2, the two plates are pressed together, forming a gap with spacing-2. During the pressing, the sample can open-flow and expand or spread in the device.

In an embodiment, the spacing-1 of the first configuration is 200 um or less. In an embodiment, the spacing-2 of the second configuration is less than the spacing of the first spacing. In an embodiment, the second spacing of the second configuration is less than the size of the cell in the liquid sample.

In an embodiment, the second spacing of the second configuration is regulated by the spacers.

In an embodiment, the plates are configured to self-maintain the second configuration after (i) the plates are compressed by an external force from the first configuration to the second configuration, and (ii) the external force is removed.

A method for assay in a spacing-changeable device using both lateral flow and compressed open flow, comprising the steps of:
(a) obtaining the device of the embodiment at a first configuration;
(b) dropping a sample onto an exterior liquid sample contact area of the device at the first configuration;
(c) the sample is guided to flow into the device;
(d) pressing the device into a second configuration;
(e) imaging and analyzing the solution in the device.

In an embodiment, the exterior liquid sample can automatically guide the sample flow into a gap between the two plates of the device by, for example, capillary force. In an embodiment, pressing the device into the second configuration enables the deposited sample to spread between the two plates and form a thin layer for an assay.

In an embodiment, the second configuration is a pressed configuration. In an embodiment, the “pressed configuration” means a configuration in which the first and second plates face each other and pressed together. In some embodiments, the pressed configuration enables the spacers and a relevant volume of a sample to be sandwiched between the two plates, and thereby the thickness of the relevant volume of the sample is regulated by the two plates and the spacers, in which the relevant volume is at least a portion of the entire volume of the sample.

In one embodiment, the average spacing-1 in configuration-1 is 10 um, 20 um, 30 um, 50 um, 100 um, 150 um, 200 um, 500 um, 1 mm, or in a range between any two of the values.

In one embodiment, the preferred average spacing-1 in configuration-1 is 30 um, 50 um, 100 um, 150 um, 200 um, or in a range between any two of the values.

In one embodiment, the average spacing-2 in configuration-2 is 1 um, 2 um, 5 um, 10 um, 20 um, 30 um, 50 um, 100 um, or in a range between any two of the values.

In one embodiment, the preferred average spacing-2 in configuration-2 is 1 um, 2 um, 5 um, 10 um, 20 um, 30 um, 50 um, or in a range between any two of the values.

In one embodiment, the signal measured is cell numbers.

In one embodiment, the signal measured is fluorescence intensity of beads.

In one embodiment, the signal measured are both bright field and fluorescence images of beads or cells.

In one embodiment, the parameters measured in each area is complete blood count including but not limited to white blood cell count, red blood cell count, platelet count, white blood cell differentiation and count, e.g., neutrophils, lymphocytes, monocytes, eosinophils and basophils—as well as abnormal cell types if they are present.

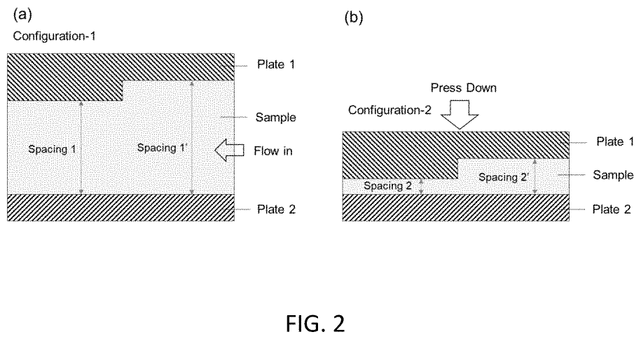

FIG. 2 shows another embodiment of the device and method for assay in a spacing-changeable device using both lateral flow and compressed open flow. The device comprises a first plate and a second plate. The sample is between the first plate and second plate. (a) At configuration-1, the two plates form at least two gaps with spacing-1 and spacing-′1′. The sample can flow into Spacing-1′ between the two plates of the device from an external inlet. (b) At configuration-2, the two plates are pressed together, forming at least two gaps with spacing-2 and spacing-′2′. During the pressing, the sample can open flow and expand in the device in both areas of spacing-2 and spacing-2′.

The devices or methods of any prior embodiment at either configuration 1 or 2, wherein the device has two areas, while each area has one spacing height.

The devices or methods of any prior embodiment at either configuration 1 or 2, wherein the device has more than two areas, while each area has one spacing height.

The liquid sample can be added to the area with higher spacing height between two areas.

The devices or methods of any prior embodiment, wherein one of the areas have a shape selected from round, polygonal, circular, square, rectangular, oval, elliptical, or any combination of the same.

The device of any prior embodiment, wherein the spacing of each area is 1 um, 2 um, 3 um, 5 um, 10 um, 20 um, 30 um, 50 um, 100 um, 150 um or in a range between any two of the values.

The device of any prior embodiment, wherein the preferred spacing of one area is 2 um, 3 um, 5 um, 10 um, or in a range between any two of the values.

The device of any prior embodiment, wherein the preferred spacing of one area is 10 um, 30 um, 50 um, 100 um, or in a range between any two of the values.

The device of any prior embodiment, wherein the difference between two spacing of each area is 0.5 μm, 1 um, 2 um, 3 um, 5 um, 10 um, 20 um, 30 um, 50 um, 100 um, 150 um, or in a range between any two of the values.

The device of any prior embodiment, wherein the ratio of the manufacturing spacing height between two areas is 1.1 fold, 1.2 fold, 1.5 fold, 2 fold, 3 fold, 5 fold, 10 fold, 30 fold, 50 fold, 100 fold, or in a range between any two of the values.

The device of any prior embodiment, wherein the area of one area is 1000 um², 2500 um², 5000 um², 10000 um², 50000 um², 1 mm², or in a range between any two of the values.

The device of any prior embodiment, wherein the area of one area is 10%, 20%, 30%, 40%, 50%, 60%, 70%, 80%, 90% of the total device area, or in a range between any two of the values.

The device of any prior embodiment, wherein the area of one area is 1 mm², 2 mm², 5 mm², 16 mm², 50 mm², 100 mm²′ or in a range between any two of the values.

The device of any prior embodiment, wherein one of the plates is fabricated by imprint lithography.

The device of any prior embodiment, wherein one of the plates is fabricated by injection molding.

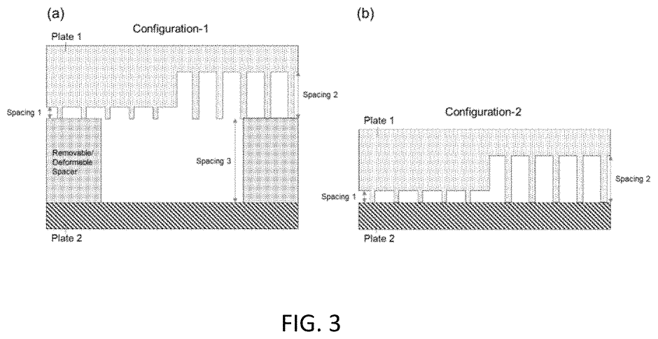

FIG. 3 shows an example of a device with changeable spacing height and configurations. (a) shows the cross-section schematic of configuration-1 and (b) shows the configuration-2. The device comprises a first plate and a second plate. The sample is between the first plate and second plate. There are two spacing areas on plate-1 with two different height spacers (spacing-1 and spacing-2). The plate-2 is flat. There is a removable or deformable spacer between the plate-1 and plate-2 with spacing height-3. After sample flowing into the device in configuration-1. The removable spacer can be removed from the device. The plate-1 and plate-2 can be pressed together to form configuration-2. In some embodiments, the spacer is deformable. During the pressing, the spacing-3 can be much less than its original value or very close to 0.

In one example of above device,

The plate 1 has a thickness of 200 um to 1500 um.

The plate 2 has a thickness of 50 um to 250 um.

The area 1 with pillar 1 array on the plate 2 has a pillar height from 3 um to 6 um with a inter pillar distance of 100 um to 200 um and a pillar size around 5 um to 40 um.

The area 2 with pillar 2 array on the plate 2 has a pillar height from 10 um to 50 um with a inter pillar distance of 100 um to 200 um and a pillar size around 10 um to 40 um.

The pillar array can also be fabricated on the plate 1.

The size of area 1 have about 0.5 mm in length and 1 mm in width.

The size of area 2 have more than 2 mm in length and 2 mm in width.

The spacing-3 is between 50 um and 150 um.

In some embodiments, the spacer for spacing-3 is made of plastic, rubber, glass, semiconductor, cellulose fibers, polymer, copolymer, and others.

In some embodiments, a coating is on at least one interior opposing surface of at least one of the plates, or both. The coating uses hydrophilic treatment, including but not limited to dielectric material coating, silicon oxide coating, plasma treatment, ozone treatment, polymer coating, acid-base treatment, surfactant chemical coating.

In some embodiments, the wetting angle at one interior surface is 10°, 20°, 30°, 45°, 60°, 75°, or in a range between any of these values.

The assay performed locally at beads or cells includes but not limited to colorimetric assay, immunoassay, cell counting, cell staining, and others.

In some embodiments, different assay is performed on different beads in the device.

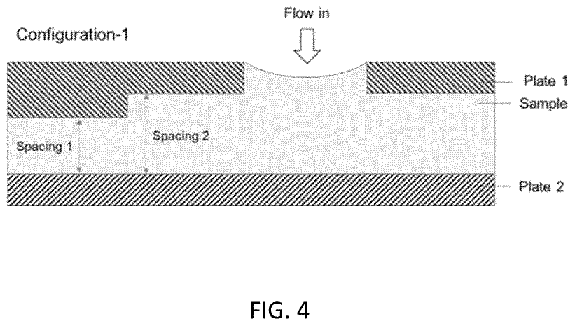

FIG. 4 shows an example of a device in configuration-1. There is one inlet on the top plate of plate 1 for sample sucking in. The advantage of this arrangement of the inlet on the top surface is to control the sample to be sucked into the center of the device in configuration-1.

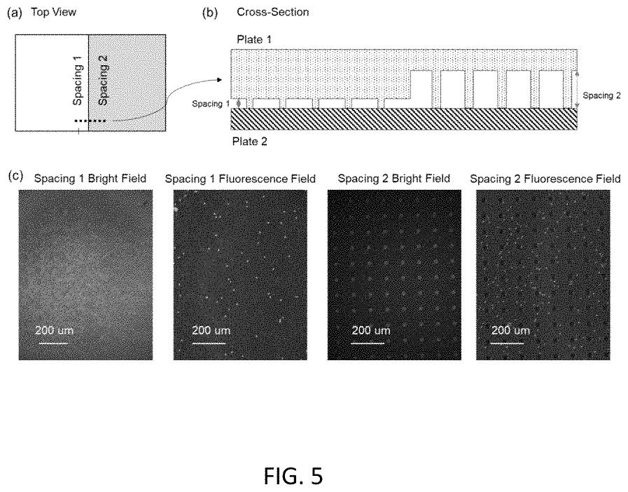

FIG. 5 shows an example of another device for blood count measurement. (a) shows the top view and (b) shows the cross-section schematic of 2 area arrangement with spacing 1 and spacing 2 on one device in configuration-2. (c) shows one example zoom-in photos of such device testing un-diluted whole blood. Both bright field and fluorescence field in spacing 1 and spacing 2 are used to analyze the whole blood sample.

The device is fabricated with the materials of polystyrene, PMMA, PC, COC, COP, or another plastic.

The plate 1 has a thickness of 200 um to 1500 um.

The plate 2 has a thickness of 50 um to 250 um.

The area 1 with pillar 1 array on the plate 2 has a pillar height from 10 um to 50 um with a inter pillar distance of 100 um to 200 um and a pillar size about 10 um to 40 um.

The area 2 with pillar 2 array on the plate 2 has a pillar height from 3 um to 6 um with a inter pillar distance of 100 um to 200 um and a pillar size about 5 um to 40 um.

The pillar array can also be fabricated on the plate 1.

The size of area 1 and area 2 have more than 0.5 mm in length and 1 mm in width.

In some embodiments of the above device, the cell stain agent comprises Wright's stain (Eosin, methylene blue), Giemsa stain (Eosin, methylene blue, and Azure B), May-Grünwald stain, Leishman's stain (“Polychromed” methylene blue (i.e., demethylated into various azures) and eosin), Erythrosine B stain (Erythrosin B), and other fluorescence stain including but not limited to Acridine orange dye, 3,3-dihexyloxacarbocyanine (DiOC6), Propidium Iodide (PI), Fluorescein Isothiocyanate (FITC) and Basic Orange 21 (BO21) dye, Ethidium Bromide, Brilliant Sulfaflavine and a Stilbene Disulfonic Acid derivative, Erythrosine B or trypan blue, Hoechst 33342, Trihydrochloride, Trihydrate, or DAPI (4′,6-Diamidino-2-Phenylindole, Dihydrochloride), or any combinations thereof.

In some embodiments, the cell separation agent comprises a surfactant, Zwittergent, CHAPS, llb, llc, lld, CTAC, Tween 20, Tween 40, Tween 60, Tween 80, SLS, CTAB, or any combinations thereof.

In some embodiments, the cell lysing agent comprises ammonium chloride, sodium bicarbonate, ethylenediaminetetraacetic acid (EDTA), acetic acid, citric acid, or other acid and base, or any combinations thereof.

The acridine orange or other staining reagents is coated onto the first plate, or the second plate or both.

The Zwittergent or other detergent is coated onto the first plate, or the second plate or both.

The acridine orange is coated on the plate with an area concentration of 1 to 20 ng/mm² and Zwittergent is coated on the plate with an area concentration of 1 to 30 ng/mm².

It is appreciated that the device and method in this disclosure may apply to the identification and assay of various biological and chemical liquid samples, including but not limited to, for example, RBC, PLT, HgB, and WBC, with or without apparent modification. Such modification should be understood as being within the scope of this disclosure.

It is to be noted that the terms “first,” “second,” and the like as used herein do not denote any order, quantity, or importance, but rather are used to distinguish one element from another. The terms “a” and “an” do not denote a limitation of quantity, but rather denote the presence of at least one of the referenced items. The modifier ‘about used in connection with a quantity is inclusive of the stated value and has the meaning dictated by the context (e.g., includes the degree of error associated with measurement of the particular quantity). It is to be noted that all ranges disclosed within this specification are inclusive and independently combinable.

It is appreciated that the device, system, and method in this disclosure may apply to various liquid samples, including a blood sample, with or without apparent modification. Such modification should be understood as being within the scope of this disclosure.

With regard to the preceding description, it is to be understood that changes may be made in detail, especially in matters of the construction materials employed and the shape, size, and arrangement of parts without departing from the scope of the present disclosure. This specification and the embodiments described are exemplary only, with the true scope and spirit of the disclosure being indicated by the claims that follow.

### Aspects

Any of Aspects 1 to 29 is combinable with any of Aspects 30 to 31.

Aspect 1. A spacing-changeable device using both lateral flow and compressed open flow for an assay, comprising:
(a) two plates including a first plate and a second plate, wherein the spacing between the two plates are changeable to form different configurations including a first configuration and a second configuration,
(b) an exterior liquid sample contact area on an exterior location of the device,

wherein at the first configuration (configuration-1), the two plates face each other and form at least two gaps including a spacing-1 and a spacing-1′, and the spacing-1′ has a spacing height larger than that of the spacing-1, the spacing height of the spacing-1′ is in a size that allows a liquid sample to flow into the spacing-1′,

at the second configuration (configuration-2), the two plates are pressed, which changes spacing-1 and spacing-1′ to a spacing-2 and a spacing-2′, respectively, and the spacing-2′ has a spacing height larger than that of the spacing-2,

at the second configuration, the sample flows and spreads in areas of spacing-2 and spacing-2′, and

the exterior liquid sample contact area comprises an inlet that allows the sample deposited thereon to flow into the spacing-1′ in the first configuration.

Aspect 2. The device of Aspect 1, wherein the spacing-1 or spacing-1′ in configuration-1 is 10 um, 20 um, 30 um, 50 um, 100 um, 150 um, 200 um, 500 um, 1 mm or in a range between any two of the values.
Aspect 3. The device of any of Aspects 1-2, wherein the spacing-2 or spacing-2′ in configuration-2 is 1 urn, 2 urn, 5 um, 10 um, 20 um, 30 um, 50 um, 100 um, or in a range between any two of the values.
Aspect 4. The device of any of Aspects 1-3, wherein the spacing-2 or spacing-2′ is 1 um, 2 um, 3 um, 5 um, 10 um, 20 um, 30 um, 50 um, 100 um, 150 um or in a range between any two of the values.
Aspect 5. The device of any of Aspects 1-4, wherein the spacing-2 is 0.5 μm, 1 um, 2 um, 3 um, 5 um, 10 um, or in a range between any two of the values.
Aspect 6. The device of any of Aspects 1-5, wherein the spacing-1′ is 10 um, 30 um, 50 um, 100 um, 150 um or in a range between any two of the values.
Aspect 7. The device of any of Aspects 1-6, wherein the ratio of the spacing height between the two gaps is 1.1 fold, 1.2 fold, 1.5 fold, 2 fold, 3 fold, 5 fold, 10 fold, 30 fold, 50 fold, 100 fold, or in a range between any two of the values.
Aspect 8. The device of any of Aspects 1-7, spacing-2 or spacing-2′ has an area of 1000 um², 2500 um², 5000 um², 10000 um², 50000 um², 1 mm², or in a range between any two of the values.
Aspect 9. The device of any of Aspects 1-8, wherein spacing-2 or spacing-2′ is 10%, 20%, 30%, 40%, 50%, 60%, 70%, 80%, 90% of the total device area, or in a range between any two of the values.
Aspect 10. The device of any of Aspects 1-9, wherein spacing-2 or spacing-2′ is 1 mm², 2 mm², 5 mm², 16 mm², 50 mm², 100 mm²′ or in a range between any two of the values.
Aspect 11. The device of any of Aspects 1-10, wherein one of the plates is fabricated by imprint lithography.
Aspect 12. The device of any of Aspects 1-11, wherein one of the plates is fabricated by injection molding.
Aspect 13. The device of any of Aspects 1-12, the spacing-2 in configuration-2 is 1 um, 2 um, 5 um, 10 um, 20 um, 30 um, 50 um, or in a range between any two of the values.
Aspect 14. The device of any of Aspects 1-13, further comprising a spacer between the first plate and the second plate,

wherein the spacer has a spacing height-3 and is removable from the device after the sample flows into the device in configuration-1.

Aspect 15. The device of Aspect 14, wherein the spacer is deformable, and during the pressing, the spacing-3 can be much less than its original value or very close to 0.
Aspect 16. The device of any of Aspects 1-15, wherein the first plate has a thickness of 200 um to 1500 um.
Aspect 17. The device of any of Aspects 1-16, wherein the second plate has a thickness of 50 um to 250 um.
Aspect 18. The device of any of Aspects 1-17, further comprising spacers disposed on the first plate, wherein the spacers form a first pillar array at the area of spacing-1 and a second pillar array at the area of spacing-1′,
Aspect 19. The device of Aspect 18, wherein the first pillar array has a pillar height from 3 um to 6 um with an inter pillar distance of 100 um to 200 um and a pillar size around 5 um to 40 um,
Aspect 20. The device of any of Aspects 18-19, wherein the second pillar array has a pillar height from 10 um to 50 um with an inter pillar distance of 100 um to 200 um and a pillar size around 10 um to 40 um.
Aspect 21. The device of any of Aspects 18-20, wherein the first and second pillar arrays are fabricated on the first plate.
Aspect 22. The device of any of Aspects 18-21, wherein the area of spacing-1 is about 0.5 mm in length and about 1 mm in width.
Aspect 23. The device of any of Aspects 18-22, wherein the area of spacing-2 is more than 2 mm in length and more than 2 mm in width.
Aspect 24. The device of any of Aspects 14-23, wherein the spacing height-3 is between 50 um and 150 um.
Aspect 25. The device of any of Aspects 14-24, wherein the spacer for spacing height-3 is made of one or more materials selected from the group consisting of plastic, rubber, glass, semiconductor, cellulose fibers, polymer, and copolymer.
Aspect 26. The device of any of Aspects 1-25, further comprising a coating on at least one interior opposing surface of at least one of the plates or both.
Aspect 27. The device of any of Aspect 26, wherein the coating uses hydrophilic treatment, including but not limited to dielectric material coating, silicon oxide coating, plasma treatment, ozone treatment, polymer coating, acid-base treatment, or surfactant chemical coating.
Aspect 28. The device of any of Aspects 1-27, wherein the wetting angle at one interior surface is 10°, 20°, 30°, 45°, 60°, 75°, or in a range between any of these values.
Aspect 29. The device of any of Aspects 1-28, wherein the device is fabricated with the materials of polystyrene, PMMA, PC, COC, COP, or another plastic.
Aspect 30. A method for an assay in a spacing-changeable device using both lateral flow and compressed open flow, comprising:
(a) obtaining the device of any of Aspects 1-29 at the first configuration;
(b) dropping a sample onto the exterior liquid sample contact area of the device at the first configuration;
(c) flowing the sample into the device;
(d) pressing the device into the second configuration;
(e) imaging and analyzing the sample in the device.
   Aspect 31. The method of Aspect 30, wherein the assay includes colorimetric assay, immunoassay, cell counting, cell staining, and/or others.

We claim:

1. A device for flowing a liquid between two plates for an assay, comprising:
a first plate and a second plate, wherein the spacing between the two plates are changeable to form different configurations including a first configuration and a second configuration,
wherein the first spacing of the first configuration is 200 um or less;
wherein the second spacing of the second configuration is less than the spacing of the first spacing.

2. The device of claim 1, wherein the second spacing of the second configuration is less than a size of the cell in the liquid sample.

3. The device of claim 1 further comprising spacers, wherein the second spacing of the second configuration are regulated by the spacers.

4. The device of claim 1, wherein the plates are configured to self-maintain the second configuration after (i) the plates are compressed by an external force from the first configuration to the second configuration, and (ii) the external force is removed.

5. The device of claim 1, further comprising an exterior liquid sample contact area on an exterior location of the device, wherein the exterior liquid sample contact area comprises an inlet that allow the sample to flow into the device in the first configuration.

6. The device of claim 1, wherein at the first configuration (configuration-1), the two plates face each other and form at least two gaps including a spacing-1 and a spacing-1′, and the spacing-1′ has a spacing height larger than that of the spacing-1, the spacing height of the spacing-1′ has a size that allows a liquid sample to flow into the spacing-1′,
in the second configuration (configuration-2), the two plates are compressed, which changes spacing-1 and spacing-1′ to a spacing-2 and a spacing-2′, respectively, and the spacing-2′ has a spacing height larger than that of the spacing-2, and
in the second configuration, the sample is compressed to flow and spread in areas of spacing-2 and spacing-2′.

7. The device of claim 1, wherein the spacing-1 or spacing-1′ in configuration-1 is 10 um, 20 um, 30 um, 50 um, 100 um, 150 um, 200 um, 500 um, 1 mm or in a range between any two of the values.

8. The device of claim 1, wherein the spacing-2 or spacing-2′ in configuration-2 is 1 um, 2 um, 5 um, 10 um, 20 um, 30 um, 50 um, 100 um, or in a range between any two of the values.

9. The device of claim 1, wherein the ratio of the spacing height between the two gaps is 1.1 fold, 1.2 fold, 1.5 fold, 2 fold, 3 fold, 5 fold, 10 fold, 30 fold, 50 fold, 100 fold, or in a range between any two of the values.

10. The device of claim 1, spacing-2 or spacing-2′ has an area of 1000 um², 2500 um², 5000 um², 10000 um², 50000 um², 1 mm², or in a range between any two of the values.

11. The device of claim 1, wherein one of the plates is fabricated by imprint lithography.

12. The device of claim 1, wherein one of the plates is fabricated by injection molding.

13. The device of claim 1, further comprising a spacer between the first plate and the second plate,
wherein the spacer has a spacing height-3 and is removable from the device after the sample flows into the device in configuration-1.

14. The device of claim 1, wherein the spacer is deformable, and during the compressing, the spacing-3 can be much less than its original value or very close to 0.

15. The device of claim 1, further comprising spacers disposed on the first plate, wherein the spacers form a first pillar array at the area of spacing-1 and a second pillar array at the area of spacing-1′,

16. The device of claim 1, wherein the first pillar array has a pillar height from 3 um to 6 um with an inter pillar distance of 100 um to 200 um and a pillar size around 5 um to 40 um,
the second pillar array has a pillar height from 10 um to 50 um with an inter pillar distance of 100 um to 200 um and a pillar size around 10 um to 40 um.

17. The device of claim 1, wherein the area of spacing-1 is about 0.5 mm in length and about 1 mm in width, and the area of spacing-2 is more than 2 mm in length and more than 2 mm in width.

18. The device of claim 13, wherein the spacing height-3 is between 50 um and 150 um.

19. The device of claim 13, wherein the spacer for spacing height-3 is made of one or more materials selected from the group consisting of plastic, rubber, glass, semiconductor, cellulose fibers, polymer, and copolymer.

20. The device of claim 1, further comprising a coating on at least one interior opposing surface of at least one of the plates, or both.

21. The device of any of claim 20, wherein the coating uses hydrophilic treatment including dielectric material coating, silicon oxide coating, plasma treatment, ozone treatment, polymer coating, acid-base treatment, or surfactant chemical coating.

22. The device of claim 20, wherein the wetting angle at one interior surface is 10°, 20°, 30°, 45°, 60°, 75°, or in a range between any of these values.

23. A method for an assay in a spacing-changeable device using both lateral flow and compressed open flow, comprising:
(a) obtaining the device of claim 1 at the first configuration;
(b) dropping a sample onto the exterior liquid sample contact area of the device at the first configuration;
(c) flowing the sample into the device;
(d) pressing the device into the second configuration;
(e) imaging and analyzing the sample in the device.

24. The method of claim 23, wherein the assay includes colorimetric assay, immunoassay, cell counting, or cell staining.

25. The device of claim 1, wherein the first spacing in the first configuration has a size of a factor of 1 (i.e., the same as the cell size), 1.4, 1.6, 1.8, 2, 2.2, 2.4, 2.8, 3 of the size of the cell in the liquid sample or in a range between any two of the above factors, and the second spacing in the second configuration has a size of 50%, 60%, 70%, 80%, 90%, 95%, 97%, or 90% of the size of the cell, or in a range between any two of the above percentages.
